(19) United States
(12) Patent Application Publication
(10) Pub. No.: US 2025/0058503 A1
(43) Pub. Date: Feb. 20, 2025

(54) METHOD FOR PRODUCING AN ACOUSTIC PROTECTION PANEL FOR A MOTOR VEHICLE

(71) Applicant: TREVES PRODUCTS,SERVICES & INNOVATION, Paris (FR)

(72) Inventors: Dominique LEMAIRE, Paris (FR); Arnaud BRUNOIS, Paris (FR); Arnaud DUVAL, Paris (FR)

(21) Appl. No.: 18/721,880

(22) PCT Filed: Dec. 16, 2022
(86) PCT No.: PCT/EP2022/086468

§ 371 Date: Jun. 20, 2024

(30) Foreign Application Priority Data
Dec. 20, 2021 (FR) FR2114023

(51) Int. Cl. B29C 43/20; B29C 43/00; B29C 43/36; B29C 43/52; B29K 75/00; B29K 105/12; B29L 31/30; B32B 25/02; B32B 25/04; B32B 25/16; G10K 11/00

(52) U.S. Cl. CPC B29C 43/203; B29C 43/003; B29C 43/361; B29C 43/52; B32B 25/02; B32B 25/045; B32B 25/16; G10K 11/002; B29C 2043/3615; B29K 2075/00; B29K 2105/12; B29K 2995/0002; B29K 2995/0064; B29K 2995/0077; B29K 2995/0094; B29L 2031/3005; B32B 2260/021; B32B 2260/046; B32B 2264/104; B32B 2307/102; B32B 2307/54; B32B 2607/00

(57) ABSTRACT

The invention relates to a method for producing an acoustic protection panel (1) for a motor vehicle, comprising a decoupling layer based on foam flakes (3) agglomerated by a heat-activatable binding agent (4), said binding agent being formed by binding fibres, said fibres comprising a core meltable at high temperature and a sheath meltable at lower temperature, said flakes being bound together by melting said sheath, so that said layer is in the form of foam flakes agglomerated by said fibres, said flakes occupying between 80% and 90% by weight of said layer, so that said fibres occupy between 20% and 10% by weight of said layer.

The invention relates to a method for producing an acoustic protection panel for a motor vehicle and to a panel obtained by such a method.

It is known to implement a method for producing an acoustic protection panel for a motor vehicle, said panel comprising an elastically compressible acoustic decoupling layer, said layer being based on a mixture of fibres bound by a heat-activatable binding agent, said method comprising the following steps:
providing a mould for successively defining a first cavity and a second, smaller-volume cavity,
pre-compressing said mixture in said first cavity and heat it to activate said agent and impart a pre-geometry to said mixture,
while maintaining heating, defining said second moulding cavity so as to over-compress said mixture to obtain said decoupling layer,
cooling said layer and removing it from said mould.

The known method involves an essentially fibrous decoupling layer, the binding agent being formed in particular by fusible fibres.

A panel produced in this way can be placed in particular on the ground or on the dashboard of the vehicle, i.e. the metal wall separating the engine compartment from the passenger compartment.

In addition to the decoupling layer, such a panel may comprise a sealed mass layer associated with said decoupling layer to form, due to the elasticity of said decoupling layer, a “mass-spring” system with acoustic insulation properties.

In another embodiment, the panel may comprise, in addition to the decoupling layer, a porous layer associated with said decoupling layer so as to form a “bi-permeable” absorbent system.

How such systems can be implemented in the context of the invention will be described later.

The method described hereinabove makes it possible to produce a three-dimensional panel in which the density of the decoupling layer can be controlled in any zone according to the expected load-bearing properties and/or acoustic behaviour.

For example, one zone-such as a “foot cellar” or a pedal zone-with accentuated density and load-bearing capacity can be provided, as well as another zone with less density.

However, with such a method, it is difficult to give the decoupling layer a precise geometry, particularly in a radiated zone of small radius—notably less than 10 mm—unless at the cost of drastic over-compression in said zone, wherein said layer becomes very compact and loses its acoustic decoupling properties.

Such behaviour may be due to the essentially fibrous nature of the decoupling layer, with the linear nature of the fibres and their long length—e.g. between 40 and 100 mm—hindering the definition of fine geometric shapes on said layer.

As a result, once the decoupling layer has been mounted on its support (in particular a metal sheet), said layer:
either does not finely match the shape of said support in the fine geometry zones, resulting in degraded damping properties, due to the lack of damping induced by the absence of contact between said layer and said support,
or is in contact with said support in said zones, but does not exhibit the expected acoustic decoupling properties due to its over-compression (Young's modulus too high).

The purpose of the invention is to propose a method that allows to overcome these drawbacks.

To this end, the invention proposes a method for producing an acoustic protection panel for a motor vehicle, said panel comprising an elastically compressible acoustic decoupling layer, said layer being based on elastically compressible foam flakes agglomerated together by a heat-activatable binding agent, said method comprising the following steps:
providing a mould provided with a die, said mould enabling the successive definition of a first cavity and a second smaller-volume cavity,
providing a homogeneous mixture of said flakes and said binding agent,
arranging said mixture in said die to form a mattress,
placing a first punch opposite said die to define a first moulding cavity that pre-compresses said mattress,
heating said pre-compressed mattress to the activation temperature of said agent so as to ensure that said flakes are pre-maintained between them,
placing a second punch opposite said die to define a second moulding cavity for over-compressing said mattress to obtain said decoupling layer,
cooling said layer and removing it from said mould,
   said method also having the following features:
said binding agent is formed by binding fibres, said fibres comprising a high-temperature meltable core and a lower-temperature meltable sheath,
said flakes are bound together by melting said sheath, so that said layer is in the form of foam flakes agglomerated by said fibres,
said flakes occupy between 80% and 90% by weight of said layer, so that said fibres occupy between 20% and 10% by weight of said layer.

The implementation of such a method applied to such a decoupling layer composition makes it possible, surprisingly, to finely shape the geometry of said layer while preserving its acoustic decoupling properties, even in zones of very fine geometry, for example having radii of the order of 5 mm, while maintaining a moderate density of said layer in said zones.

A judicious choice of flake size allows to refine the geometric definition of the decoupling layer at will, since a reduction in flake size leads to an improvement in geometric definition.

Further features and advantages of the invention will become apparent from the following description made with reference to the attached figures, in which:

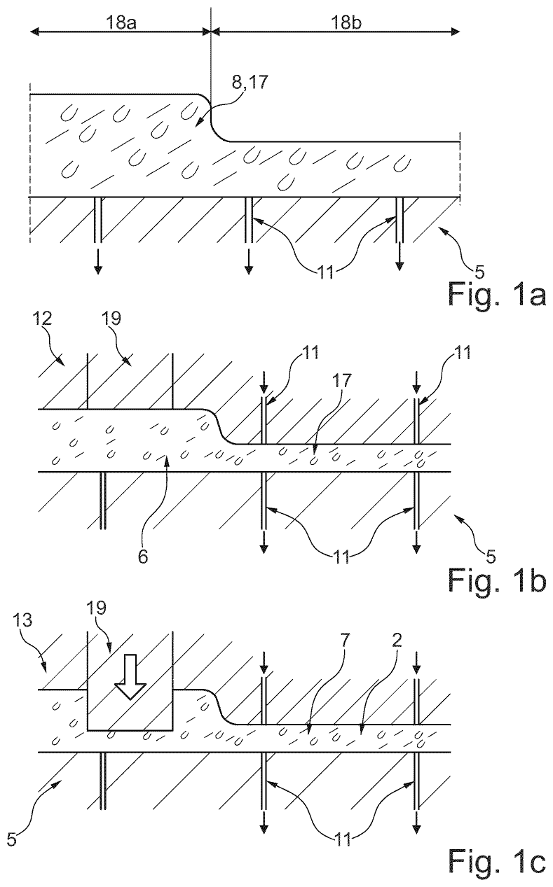

FIG. 1a, FIG. 1b and FIG. 1c represent different steps of the method, in partial schematic section, according to an embodiment, FIG. 1a representing the step of placing the mixture in the die to form a mattress, FIG. 1b the pre-conformation of said mattress in the first cavity and FIG. 1c the conformation of said mattress by over-compression in the second cavity to obtain the decoupling layer,

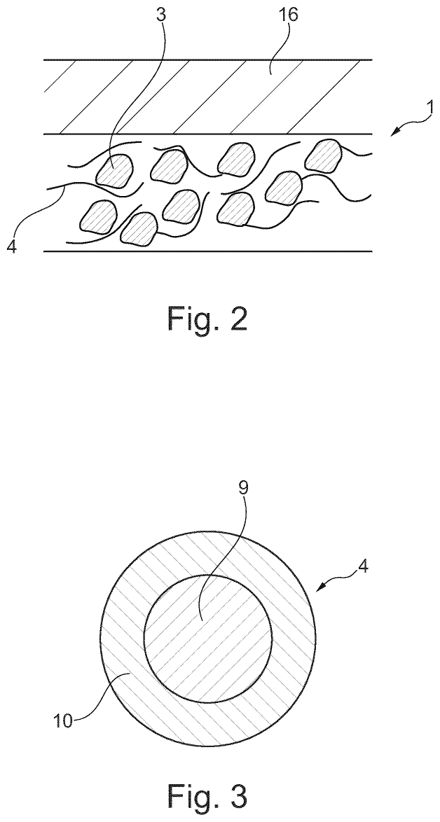

FIG. 2 shows a panel according to one embodiment, with the decoupling layer associated with a mass layer.

FIG. 3 shows a schematic cross-section of a binding fibre.

With reference to the figures, we describe a method for producing an acoustic protection panel 1 for a motor vehicle, said panel comprising an elastically compressible acoustic decoupling layer 2, said layer being based on elastically compressible foam flakes 3—in particular from used bedding mattresses—agglomerated together by a heat-activatable binding agent 4, said method comprising the following steps:
providing a mould provided with a die 5, said mould making it possible to successively define a first cavity 6 and a second, smaller-volume cavity 7,
providing a homogeneous mixture 8 of said flakes and said binding agent,
arranging said mixture in said die to form a mattress 17,
placing a first punch 12 opposite said die to define a first moulding cavity 6 that pre-compresses said mattress,
heating said pre-compressed mat to the activation temperature of said agent so as to ensure that said flakes are pre-maintained between them,
positioning a second punch 13 opposite said die to define a second moulding cavity 7 for over-compressing said mattress to obtain said decoupling layer,
cooling said layer and removing it from said mould,
   said process also having the following features:
said binding agent is formed by binding fibres, said fibres comprising a high-temperature meltable core 9 and a lower-temperature meltable sheath 10,
said flakes are bound together by melting said sheath, so that said layer is in the form of foam flakes agglomerated by said fibres,
said flakes occupy between 80% and 90% by weight of said layer, so that said fibres occupy between 20% and 10% by weight of said layer.

The heating and cooling described hereinabove can be achieved in particular by a flow of air (symbolized by arrows in FIGS. 1b and 1c) brought to the chosen temperature, here via orifices 11 provided for this purpose in the die 5 and the punches 12, 13.

In another embodiment, heating is performed by steam under pressure.

According to one embodiment, the flakes 3 occupy between 83% and 87% by weight of the lower layer 2, and in particular of the order of 85%, so that the fibres 4 occupy between 17% and 13% by weight of said layer.

According to various embodiments, the flakes 3 have the following characteristics:
they are polyurethane-based,
and/or their density before compression is between 15 and 80 kg/m³,
and/or 90% of said flakes have a maximum dimension before compression of between 5 and 20 mm, and in particular less than 10 mm,
and/or their Young's modulus before compression is less than 50 kPa.

In one embodiment, the mixture 8 is sprayed under pressure into the die 5.

According to one embodiment, the fibres 4 have a titre of between 1.7 and 6.7 dtex, being in particular of the order of 4.4 dtex.

The use of relatively fine fibres 4 favours absorption by visco-thermal dissipation, which has a favourable effect on acoustic decoupling efficiency.

In one embodiment, the core 9 is polyester-based and the sheath 10 is co-polyester-based.

In one embodiment, the mattress 17 is pressed against the die 5 by suction (symbolized by arrows in FIG. 1a) through orifices 11 provided in said die.

According to the embodiment shown, the mixture 8 is arranged inhomogeneously in the die 5 in at least two zones 18a, 18b, so that the mass per unit area of the mattress 17 differs from one of said zones to the other.

The local density of the decoupling layer 2 obtained is a function of the compression ratio achieved in each of its zones during its conformation to its final geometry in the second cavity 7.

In particular, a higher density can be provided in zones requiring high load-bearing capacity, such as the “foot cellars” of a floor covering, while maintaining good acoustic decoupling, even for very high densities of the decoupling layer 2, for example of the order of 300 kg/m³.

In particular, a density of between 50 and 80 kg/m³ in the low-compression zone and between 100 and 200 kg/m³ in the high-compression zone can be envisaged.

In the same way, in a variant not shown, the density of the decoupling layer 2 can be increased locally in zones comprising orifices for the passage of functional members, such as the steering column, in order to ensure that said layer is properly pressed against said member, and therefore provides a good acoustic seal.

According to the embodiment shown, the second punch 13 is formed by deformation of the first punch 12, said first punch being provided with at least one movable part 19 which can be actuated to achieve over-compression of the mattress 17 opposite said part.

According to one embodiment, illustrated in FIG. 2, the method further comprises the step of associating, for example by gluing, a mass layer 16 with the decoupling layer 2, so as to form a “mass-spring” system.

According to various embodiments, the mass layer 16, which can be located only on a part of the decoupling layer 2, is formed optionally by:
either a dense, watertight layer; such a dense layer may, for example, be based on EPDM filled with a mineral filler, such as calcium carbonate; it may in particular have a weight per unit area of between 1000 and 4000 g/m²; according to one embodiment, said dense layer may be coated with a porous layer, for example fibrous, intended to provide additional acoustic absorption and/or an advantageous appearance,
or a waterproof film, e.g. with a thickness of between 50 and 150 microns, coated with a stiff porous acoustic absorption layer, e.g. fibrous—which may in particular have a mass per unit area of between 1000 and 2500 g/m²—said porous layer contributing essentially to the mass of said mass layer.

Prior to its association with the decoupling layer 2, the mass layer 16 can be conformed to the geometry of said decoupling layer once it has been formed, so as to precisely match its geometry.

According to a further embodiment not shown, the method further comprises the step of associating an air-permeable porous layer with the decoupling layer 2, so as to form a “bi-permeable” system.

The porous layer is, for example, made of compressed felt or of foam flakes compressed and agglomerated by binding fibres.

The porous layer may, for example, have an air passage resistance of between 500 and 2500 N·s·m³.

Finally, a panel 1 made by such a method is described, said panel comprising a decoupling layer 2, said layer comprising:
flakes 3 of elastically compressible foam,
binding fibres 4, said fibres comprising a high-temperature meltable core 9 and a lower-temperature meltable sheath 10,
   knowing that:
said flakes are bound together by melting said sheath, so that said layer is in the form of foam flakes agglomerated by said fibres,
said flakes occupy between 80% and 90% by weight of said layer, so that said fibres occupy between 20% and 10% by weight of said layer,
   said decoupling layer having at least one radiated zone with a radius of between 2 and 10 mm.

In one embodiment, the radiated zone has a Young's modulus in compression of less than 150 kPa and a density of less than 300 kg/m³.

In one embodiment, the decoupling layer 2 has zones 18a, 18b of different densities.

1. A method for producing an acoustic protection panel (1) for a motor vehicle, said panel comprising an elastically compressible acoustic decoupling layer (2), said layer being based on elastically compressible foam flakes (3) agglomerated together by a heat-activatable binding agent (4), said method comprising the following steps:
providing a mould provided with a die (5), said mould making it possible to successively define a first cavity (6) and a second smaller-volume cavity (7),
providing a homogeneous mixture (8) of said flakes and said binding agent,
arranging said mixture in said die to form a mattress (17),
placing a first punch (12) opposite said die to define a first moulding cavity (6) that pre-compresses said mattress,
heating said pre-compressed mattress to the activation temperature of said agent so as to ensure that said flakes are pre-maintained between them,
placing a second punch (13) opposite said die to define a second moulding cavity (7) for over-compressing said mattress to obtain said decoupling layer,
cooling said layer and removing it from said mould,
said method also having the following features:
said binding agent is formed by binding fibres, said fibres comprising a core (9) meltable at high temperature and a sheath (10) meltable at lower temperature,
said flakes are bound together by melting said sheath, so that said layer is in the form of foam flakes agglomerated by said fibres,
said flakes occupy between 80% and 90% by weight of said layer, so that said fibres occupy between 20% and 10% by weight of said layer.

2. A method according to claim 1, characterized in that the flakes (3) occupy between 83% and 87% by weight of the decoupling layer (2), so that the fibres (4) occupy between 17% and 13% by weight of said layer.

3. A method according to claim 1, characterized in that the flakes (3) have the following characteristics:
they are polyurethane-based,
and/or their density before compression is between 15 and 80 g/m³,
and/or 90% of said flakes have a maximum dimension before compression of less than 10 mm,
and/or their Young's modulus before compression is less than 50 kPa.

4. A method according to claim 1, characterized in that the mixture (8) is sprayed under pressure into the die (5).

5. A method according to claim 1, characterized in that the mattress (17) is pressed against the die (5) by suction through orifices (11) provided in said die.

6. A method according to claim 1, characterized in that the mixture (8) is arranged inhomogeneously in the die (5) in at least two zones (18a, 18b), so that the mass per unit area of the mattress (17) differs from one of said zones to the other.

7. A method according to claim 1, characterized in that the second punch (13) is formed by deformation of the first punch (12), said first punch being provided with at least one movable part (19) which can be actuated to achieve an over-compression of the mattress (17) opposite said part.

8. A method according to claim 1, characterized in that it further comprises the step of associating a mass layer (16) with the decoupling layer (2), so as to form a “mass-spring” system.

9. A method according to claim 1, characterized in that it further comprises the step of associating an air-permeable porous layer with the decoupling layer (2), so as to form a “bi-permeable” system.

10. Panel (1) made by a method according to claim 1, said panel comprising a decoupling layer (2), said layer comprising:
elastically compressible foam flakes (3),
binding fibres (4), said fibres comprising a high-temperature meltable core (9) and a lower-temperature meltable sheath (10),
knowing that:
said flakes are bound together by melting said sheath, so that said layer is in the form of foam flakes agglomerated by said fibres,
said flakes occupy between 80% and 90% by weight of said layer, so that said fibres occupy between 20% and 10% by weight of said layer,
said decoupling layer having at least one radiated zone with a radius of between 2 and 10 mm.
